(19) United States
(12) Patent Application Publication
(10) Pub. No.: US 2026/0049805 A1
(43) Pub. Date: Feb. 19, 2026

(54) Tape measure with detachable reference blade

(71) Applicant: Reekon Tools Inc., East Boston, MA (US)

(72) Inventors: Konstantinos Oikonomopoulos, Boston, MA (US); Edgar Sutawika, Cambridge, MA (US); Bartlomiej Saminski, Boston, MA (US)

(21) Appl. No.: 18/808,151

(22) Filed: Aug. 19, 2024

(51) Int. Cl. G01B 3/1089; G01B 3/1046

(52) U.S. Cl. CPC G01B 3/1089; G01B 3/1046

(57) ABSTRACT

A reference blade that allows a user to attach a reference surface to the body of a tape measuring device to allow for integrated measuring and marking/scribing a full line. The tape measuring device may be a digital linear tape measure. The reference blade couples to the body of the tape measure, which both secures the blade to the body as well as allows it to be removably detached and thereafter re-attached to the body at a specific and repeatable working location. The reference blade comes in a variety of sizes, shapes, and geometries and may be stored (in a different mounting state or attached) to the tape measure or externally. The reference blade addresses the need to provide the user with a sufficiently long surface that can be used for marking.

### BACKGROUND OF THE INVENTION

This disclosure relates generally to measuring devices and methods.

It is known in the prior art to augment a conventional tape measure device with measuring and processing components that enable greater accuracy to the measurements made by the device. One such example is described and depicted in U.S. Pat. No. 11,460,284, the disclosure of which is hereby incorporated by reference. In a representative embodiment, the device has a housing that supports a display on which measurements are rendered. To take a measurement, a tape measure is extended from the housing at a given distance of interest. The tape measure includes unit length markings. The device housing supports a positional encoder, a processor, and memory/storage that supports control software executed by the processor to control the device. In particular, the control software is configured to process positional information received from the positional encoder, compute a linear location of the measuring tape (its degree of extension from the housing, as measured by the unit length markings), and to generate one or more control signals to drive the display to render positional data

Oftentimes when a user is using a ruler or other measurement instrument (such as the digital tape measure described above), lines are used to make a mark at a specific location. A marking gauge or similar tool may be used for this purpose. This mark, however, frequently does not suffice, in which case a secondary tool may be required to extend the line. Having to handle two different tools is clumsy are hard to execute successfully.

### SUMMARY OF THE INVENTION

This disclosure provides for a reference blade that allows a user to attach a reference surface to the body (housing) of a tape measuring device to allow for integrated measuring and marking/scribing a full line. The tape measuring device may be a digital linear tape measure. Preferably, the reference blade couples to the body of the tape measure, which both secures the blade to the body as well as allows it to be aligned (relative to the body) to one or more specific and repeatable working locations. The reference blade comes in a variety of sizes, shapes, and geometries and may be stored (in a different mounting state or attached) to the tape measure or externally. The reference blade addresses the need to provide the user with a sufficiently long surface that can be used for marking.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts a representative digital tape measure with a first embodiment of the reference blade of this disclosure secured for storage to a bottom surface thereof;

FIG. 2 depicts the reference blade in FIG. 1 being slidably removed from the tape measure for use to facilitate a marking;

FIG. 3 depicts a reference blade in association with the digital tape measure in various configurations to facilitate a marking;

FIG. 4 depicts the reference blade separated from the digital tape measure and details of a snap-fit interface used to mount the blade into its storage position in this embodiment;

FIG. 5 depicts the reference blade being attached to the snap-fit interface to facilitate a marking;

FIG. 6 depicts the tape measure and reference blade arrangement for use in marking a top surface of a workpiece;

FIG. 7 depicts an alternative configuration of the tape measure and the reference blade arranged for use in marking a side of a workpiece;

FIG. 8 depicts an alternative embodiment of the reference blade.

### DETAILED DESCRIPTION OF THE INVENTION

As noted above, the subject matter of this disclosure is a reference blade for use in association with a digital linear measuring device. The blade may also be used (or retrofitted to) a conventional (analog) tape measure. The particular tape measure to which the reference blade is coupled (for storage and use) thus is not a limitation of this disclosure. The remainder of this description, and the accompanying drawings, provide for an embodiment wherein the reference blade is associated to a digital tape measure. As will be seen, the reference blade is configured to be carried by the tape measure, and is user-removable (and replacement). Typically, the reference blade is formed of a same material as used for the tape measure blade itself, e.g., aluminum or stainless steel, although other materials, such as a plastic, may also be used. As described, the reference blade allows a user to attach a reference surface to the body (or housing) of a tape measuring device to allow for integrated measuring and marking/scribing a full line. In a typical use case, the reference blade couples to the body of the tape measure, which both secures the blade to the body as well as allows it to be aligned to a specific and repeatable working location. The reference blade comes in a variety of sizes, shapes, and geometries and may be stored (in a different mounting state or attached) to the tape measure or externally.

The reference blade of this disclosure (sometimes referred to as a “marking” blade) is useful as a standalone marking device, although as will be described below, typically it will be mountable in one or more configurations (sometimes referred to herein as “specific and repeatable positions”) on the tape measure device itself to provide for different working locations that facilitate marking arrangements, e.g., measuring with an edge as a reference, and measuring on a plane (wherein an edge reference would be an obstruction). The reference blade typically has markings and/or indentations to facilitate scribing or secondary measuring. In one example, but non-limiting use case, the user measures in one dimension using the tape measure, and then in a second dimension using the reference blade.

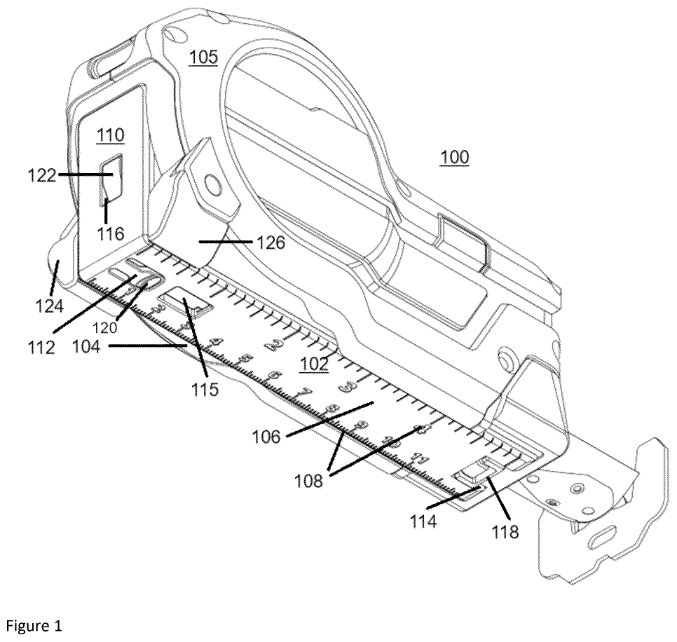

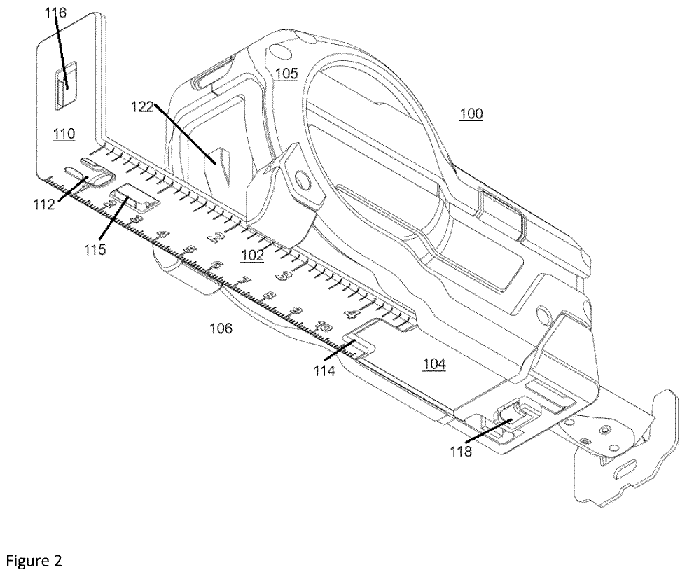

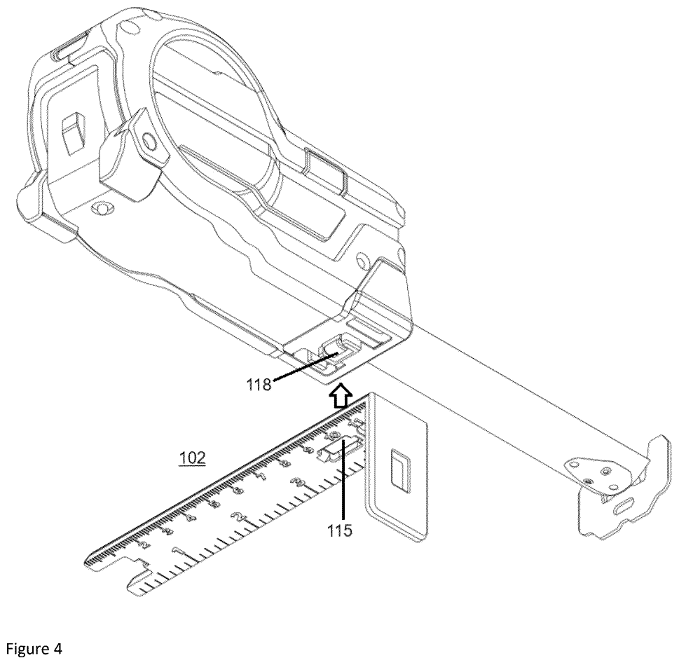

FIG. 1 depicts a representative digital tape measure 100 with a first embodiment of the reference blade 102 of this disclosure secured for storage to a bottom surface 104 of the tape measure housing 105. The reference blade comprises a first (main body) portion 106 with markings 108, and a second (upstanding) end portion 110. The markings typically are present on both sides of the first portion. As best seen in FIG. 4, the reference blade first portion includes cutouts 112 and 114, and the second portion includes cutout 116. These cutouts are configured to mate with interface structures on the tape measure. In particular, and once again as best seen in FIG. 4, in this embodiment the tape measure is configured with a first support fitting (or attachment point) 118 located along the bottom of the housing and toward the front of the device (where the tape measure exists the housing), a second support fitting 120 also located along the bottom and near the back of the housing, and a third support fitting 122 located along a back surface of the housing. These fittings are configured to mate with the cutouts 112, 114 and 116 of the reference blade. To this end, and as shown in FIG. 1, the reference blade is stored in a fully stored position by the snap fit interface components and configuration, and in this position rotation of the blade relative to the housing is prevented by virtue of the cutout 116 and third support fitting 122, which locks the blade against any such rotation. The reference blade is removable from this locked position by simple lateral sliding of the blade relative to the housing bottom, such as depicted in FIG. 2. As also shown in FIGS. 1, 2 and 4, the housing 105 may also include one or more side-supported guide structures 124 and 126 through which the blade passes as it is slidably removed from its tape measure storage position.

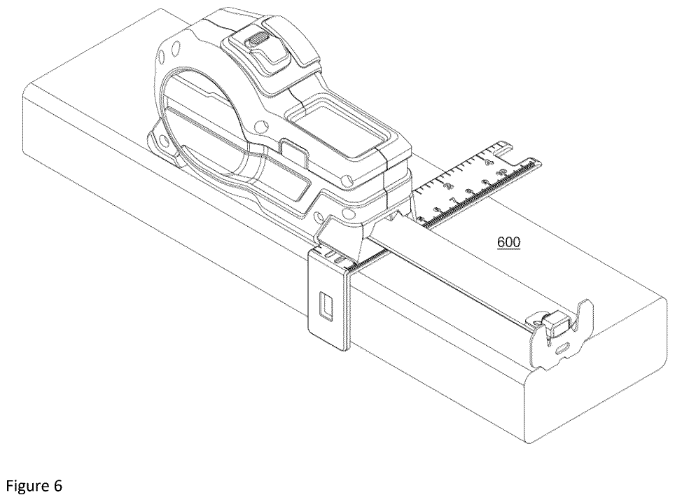

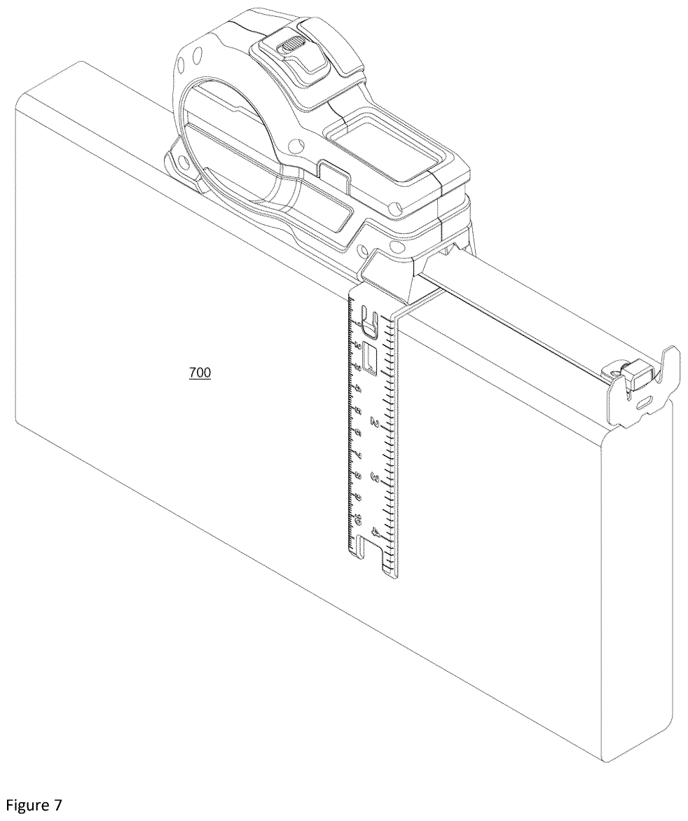

As also seen in FIGS. 1 and 4, the reference blade includes a cutout 115 located near an end of the tape measure, i.e., near where the markings begin. In FIG. 1 (a storage position), cutout 115 is not mated to any fitting of the housing. In FIG. 4, and as depicted by the arrow, cutout 115 is configured to be mated to the first support fitting 118 to enable the reference blade to be selectively positioned in a working position. The resulting working position is best shown in FIG. 6. In a variant arrangement, the cutout 116 in the end portion 110 of the reference blade is configured to be mated to the first support fitting 118. This resulting working position is best shown in FIG. 7. Thus, the arrangements shown in FIGS. 6 and 7 depict specific and repeatable positioning of the reference blade in multiple working positions.

The particular configuration of the support fittings 118, 120, and 122, and the guide structures 124 and 126 may vary, and various existing structures of the tape measure housing may be used. In FIG. 1, the digital tape measure housing is configured (e.g., during manufacture) to includes these support fittings and guide structures, but this is not a requirement, as similar elements may be configured to an existing tape measure as an after-market retrofit arrangement. It is not required that all three of the support fittings being used, and one of ordinary skill in the art will appreciate that the number, position and configuration of these elements will depend on the number, position and configuration of the cutouts of the reference blade. In a variant embodiment, and although less desirable, the cutouts may be located on the housing, in which case the reference blade includes mating projections. Further, while the depicted reference blade cutout arrangement and housing support fittings and guide structures comprise a preferred embodiment of the snap-fit interface, other types of mounting fasteners and mounting methods may be used.

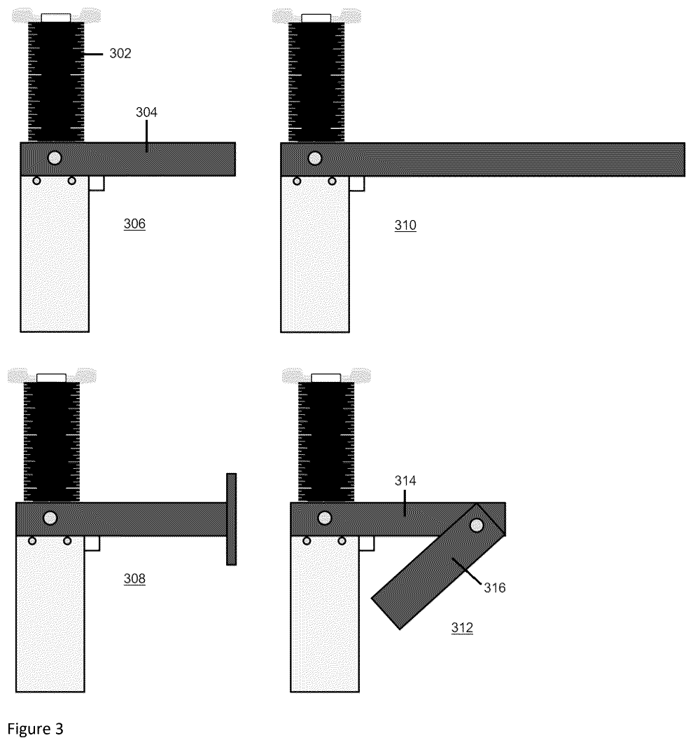

FIG. 3 depicts various arrangements of the reference blade for use in marking on the digital tape measure itself. In these views, the digital tape measure 300 has its tape measure blade 302 extended to a position. The reference (marking) blade 304 is attached to the housing at the front thereof at a specific and repeatable position, and an edge of the blade 304 is thus useful to facilitate the marking. This is a “working” position. In the arrangement shown, which is not intended to be limiting, there are several different reference blade configurations 306, 308, 310 and 312 for the working position. Configurations 306 and 308 correspond to the reference blade structure shown in FIGS. 1, 2 and 4. Configuration 310 shows the use of an extended (longer) reference blade, and configuration 312 depicts the use of a reference blade that has a main section that itself has a first portion 314, and a second section 316 that is rotatable relative to the first portion 314. More specifically, the section 316 is an angled section that is configured to be positioned in an adjustable angle relative to the first portion 314. This angled section may be positioned, e.g., to obtain a 90° reference, or some other adjustable angle. In a variant embodiment the section 316 may have a fixed angle (e.g., 90°) relative to the first portion 314.

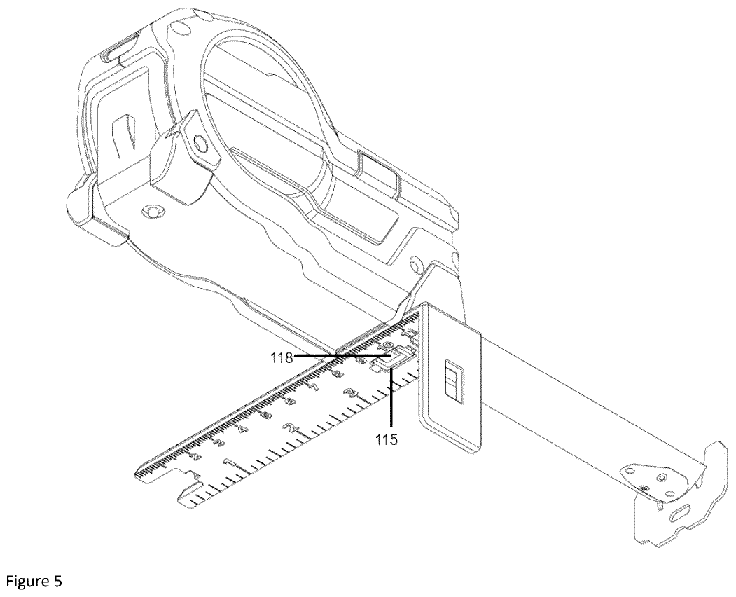

As previously noted, FIG. 4 depicts the reference blade 102 separated from the digital tape measure. FIG. 5 depicts the reference blade being attached to the snap-fit interface into a working position to facilitate a marking. As previously explained, and in this example, the cutout 115 of the reference blade is mated with the first support fitting 118 adjacent the front of the housing. This is configuration 306 in FIG. 3.

FIG. 6 is a perspective front view that depicts the working position for the tape measure and reference blade arrangement (of FIGS. 4-5) being used to mark a top surface of a workpiece 600.

FIG. 7 depicts another of the specific and repeatable working positions, with the tape measure and reference blade arrangement configured to facilitate marking of a side surface of a workpiece 700.

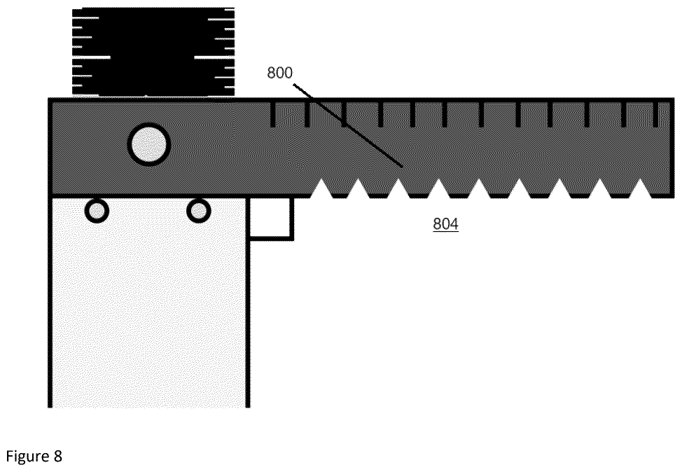

FIG. 8 depicts an alternative embodiment of the reference blade 800 that in lieu of having measurement indicia printed on the top or bottom, instead comprises a set of serrations/indentations 804 that function as such indicia. The blade may include both measurement indicia and indentations.

The above-described embodiments provide significant advantages. The reference blade is user-removable and replacement, and it can be used as a standalone marking device or, in the usual case, in association with the tape measure. The reference blade has markings (typically on both facing sides) to facilitate scribing or second measuring. In a typical second measuring use case, the user measures in one dimension using the tape measure and then in a second dimension using the reference blade. The housing comprises an attachment (e.g., a snap fit interface) to both receive and store the reference blade, which is slidably-detachable from the housing for use, and to facilitate placement of the reference blade relative to the housing into one of many different working positions. The attachment, which typically comprises some structural element of the blade together with some structural element of the housing, thus enables the reference blade to be placed into specific and repeatable positions for both storage and use. In a particular embodiment of the attachment, the reference blade is configured with one or more cutouts that mate with associated support fittings on the housing to facilitate mounting of the reference blade in multiple configurations serving different functions, e.g., measuring with an edge as a reference, and measuring on a plane (where an edge reference would be an obstruction).

As noted, the above-described configurations are merely representative, as the blade can be configured in a variety of sizes, shapes, and geometries. In variant embodiments, the reference blade is stored in a different mounting state or attached to the tape measure in other mounting locations. Generalizing, any given structure of the reference blade together with any given structure of the housing together comprise an attachment that is configured to secure the reference blade to the housing in a specific and repeatable storage position (location) from which the reference blade is then detachable for use in association with the tape measure; likewise, when detachable, the reference blade (using the attachment) is then brought into a specific and repeatable working position such as depicted in FIGS. 3 and 6-7. Thus, the snap fit interface shown in the embodiment depicted is just one type of attachment that may be utilized. Any attachment or fastener that secures the reference blade so that it is aligned and held in a specific and repeatable location with respect to the tape measure housing for storage and/or working positions may be used.

As has also been described, and depending on implementation and the specific attachment(s) that are configured, the reference blade is mountable in multiple orientations with respect to the housing.

Having described the subject matter herein, what we now claim is set forth below.

1. A tape measure system, comprising:
a tape measure having a housing;
a reference blade; and
an attachment comprising a structure of the reference blade together with a structure of the housing configured to secure the reference blade to the housing in a specific and repeatable position in one of: a storage position from which the reference blade is detachable for use, and a working position.

2. The tape measure system as described in claim 1, wherein the attachment is a snap fit interface comprising a set of one or more cutouts in the reference blade and one or more associated support fittings on the housing, the snap fit interface (i) coupling the reference blade to the housing in the storage position, (ii) facilitating slidable detachment of the reference blade from the housing, and (iii) following the detachment, re-attaching the reference blade to the housing in the working position.

3. The tape measure system as described in claim 2, wherein the housing comprises a bottom surface, and a back surface.

4. The tape measure system as described in claim 3, wherein the support fittings comprise at least a first support fitting on the bottom surface, and a support fitting on the back surface.

5. The tape measure system as described in claim 3, wherein the support fittings comprise a first support fitting on the bottom surface adjacent a front portion of the housing, a second support fitting on the bottom surface adjacent a back portion of the housing, and a third support fitting on the back surface of the housing.

6. The tape measure system as described in claim 5, wherein the reference blade comprises a first portion, and a second portion angled relative to the first portion.

7. The tape measure system as described in claim 6, wherein the first portion of the reference blade comprises first and second cutouts configured to mate with the first and second support fittings, and wherein the second portion of the reference blade comprises a third cutout configured to mate with the third support fitting.

8. The tape measure system as described in claim 7, wherein the second cutout of the reference blade mates with the first support fitting of the housing to position the reference blade into the working position.

9. The tape measure system as described in claim 1, wherein the reference blade has measurement indicia.

10. The tape measure system as described in claim 1, wherein the tape measure is one of: a digital tape measure, and an analog tape measure.

11. The tape measure system as described in claim 1, wherein the reference blade has one or more indentations as measurement indicia.

12. A reference blade for use in association with a tape measure having a housing, the housing having one or more support fittings, comprising:
a first portion, and a second portion angled relative to the first portion;
the first portion and the second portion including one or more cutouts configured to mate with the one or more support fittings to facilitate storage of the reference blade in association with the housing, slidably-removable detachment of the reference blade relative to the housing, and selective re-attachment of the reference blade to the housing into a working position.

13. The reference blade as described in claim 12, wherein the first portion comprises an angled section that is configured to be positioned in a fixed or adjustable angle relative to the first portion.
